(19) United States
(12) Patent Application Publication
(10) Pub. No.: US 2020/0399148 A1
(43) Pub. Date: Dec. 24, 2020

(54) METHOD AND APPARATUS FOR ELECTROCHEMICAL pH CONTROL

(71) Applicant: BAR-ILAN UNIVERSITY, Ramat Gan (IL)

(72) Inventors: Eran AVRAHAM, Petah Tikva (IL); Izaak COHEN, Petah Tikva (IL); Doron AURBACH, Bnei-Brak (IL)

(21) Appl. No.: 16/968,720

(22) PCT Filed: Feb. 18, 2019
(86) PCT No.: PCT/IL2019/050193

§ 371 Date: Aug. 10, 2020

(30) Foreign Application Priority Data
Feb. 18, 2018 (IL) 257589

(51) Int. Cl. C02F 1/467; C25B 15/02; C25B 1/26; C25B 9/06; C02F 1/461; A01N 59/00

(52) U.S. Cl. CPC C02F 1/4674; C25B 15/02; C25B 1/26; C02F 2101/306; C02F 1/46109; A01N 59/00; C02F 2001/46152; C25B 9/06

(57) ABSTRACT

The present invention relates to the production of electrolyzed aqueous solutions in an electrochemical cell. More particularly, the invention relates to an asymmetric electrochemical cell device for producing electrolyzed water or aqueous solution, while controlling the pH of the solution. The invention further relates to methods of operating said device and to the use thereof for microbial disinfection and/or pesticide removal.

### FIELD OF THE INVENTION

The present invention relates to the production of electrolyzed aqueous solutions in an electrochemical cell. More particularly, the invention relates to an asymmetric electrochemical cell device for producing electrolyzed water or aqueous solution, while controlling the pH of the solution. The invention further relates to methods of operating the device of the invention and to the use thereof for microbial disinfection and/or pesticide removal.

### BACKGROUND OF THE INVENTION

It is known in the art that the contact with liquids at different pH levels may have a desirable effect. For instance, a low pH is useful in destroying harmful bacteria, while both low and high pHs may be useful to destroy a variety of undesirable chemical agents that are sensitive to pH changes. The art has provided a variety of methods for controlling the pH of aqueous solutions, for instance, by the introduction of various chemicals. However, there still is a need for a simple and efficient method to control pH values in a variety of applications.

A typical electrochemical cell arrangement is illustrated in FIG. 1, which is a schematic illustration of an electrochemical cell 100 for producing electrolyzed water, according to the prior art. The electrochemical cell typically contains two compartments within a cell housing 101, namely a positive compartment 102 in which a positive electrode (anode) 105 is located, and a negative compartment 103 in which a negative electrode (cathode) 106 is present. The two compartments are separated by an ion-exchange membrane 104.

When an illustrative solution of salt water (aqueous NaCl) feed 108 is introduced to each compartment of the cell, and the electrodes are electrically connected to a suitable power supply 107, a number of chemical reactions take place over the electrodes, which may be represented as follows:
(1) At the positive electrode (anode) 105:

2H₂0₍ₗ₎→4H⁺_{(aq)}+O_{2(g)}+4e⁻

2NaCl_{(aq)}→Cl_{2(g)}+2Na⁺_{(aq)}+2e⁻

Cl_{2(g)}+H₂0₍ₗ₎→HCl_{(aq)}+HOCl_{(aq)}.
(2) At the negative electrode (cathode) 106:

2H₂0₍ₗ₎+2e⁻→20H⁻_{(aq)}+H_{2(g)}.

At the positive electrode 105, water is electrolyzed to form hydrogen ions and oxygen. Sodium chloride forms chlorine, which subsequently reacts with water to form HCl and HOCl. Hence, an acidic water discharge 109 is typically obtained from the positive compartment 102 of the electrochemical cell 100, having a pH value within a range of 2-6. The membrane 104 allows the transfer of cations (such as Na⁺), which traverses the membrane 104 and enters the negative compartment 103 of the electrochemical cell 100. Simultaneously, at the negative electrode 106, hydroxide (OH⁻) is liberated, and hydrogen is evolved. Thus, an alkaline water discharge 110, which may contain NaOH_{(aq)}, is typically obtained from the negative compartment 103 of the electrochemical cell 100, having a pH value of 8-13.

Such electrochemical cells require a membrane, and also electrodes which are typically expensive (e.g., based on titanium alloys and pure graphite) and may be largely inert in the harsh electrolytic conditions.

An attempt was made to provide asymmetric electrochemical apparatus for this purpose, as described in WO 2017/064577. However, it was surprisingly found that the operating parameters taught therein fail to achieve the required results and, in fact, teach away from the operation conditions needed to accomplish them.

It is therefore an object of the present invention to provide an improved stable electrochemical device and methods for producing electrolyzed water that overcomes the disadvantages of the prior art and can be efficiently utilized for the abovementioned purposes.

It is another object of the invention to provide a method for producing a hypohalous acid (HOX) in an aqueous solution containing alkali metal cations and halogen anions corresponding to the hypohalous acid using an asymmetric electrochemical cell device.

Other objects and advantages of the invention will become apparent as the description proceeds.

### SUMMARY OF THE INVENTION

In one aspect there is provided a device for generating an aqueous solution having a desired pH using an asymmetric electrochemical cell, comprising:
a cell housing;
at least one positive electrode within the cell housing;
at least one negative electrode within the cell housing; and
a power supply;

wherein the surface area of one of the electrodes is higher than the surface area of the opposite charged electrode by a differential determined by the equation:

pH=7×(1−n)+n×log[96485×V/(((([A⁻]−[A⁺])×n×ε/d)−C_{sd})×f×E)],

wherein:
pH is the desired pH of the aqueous solution;
V is the volume of the aqueous solution disposed within the device;
[A⁻] is the nominal surface area of the negative electrode;
[A⁺] is the nominal surface area of the positive electrode;
n is 1 when the negative electrode is the higher surface area electrode, or n is −1 when the positive electrode is the higher surface area electrode.
ε is the permittivity constant;
d is the distance between the surface adsorbed ions and the opposite charged electrode in an electrical double layer;
C_{sd} is the total self-discharge capacity of the high surface area electrode;
f is a normalizing factor; and
E is the overall electric potential of the electrochemical cell.

According to one embodiment of the invention the normalizing factor is obtained by determining a theoretical surface area of a first electrode using the resulting pH from a plurality of experiments, determining the ratio between the theoretical surface area and an experimental surface area of said electrode for each pH obtained from a separate experiment, and averaging the ratios between the theoretical surface area and the experimental surface area of said electrode for each of said resulting pHs, to obtain the normalizing factor for a specific combination of electrodes.

In some embodiments of the invention, the high surface area electrode of the device is surface-treated, such that it is continuously self-discharged. According to a specific embodiment, the high surface area electrode is grounded. According to another specific embodiment, the high surface area electrode comprises oxide functional groups.

In one embodiment of the invention the device is a sprayer device. In another embodiment of the invention the device is a towelette.

Also encompassed by the invention is a method of operating an asymmetric electrochemical cell device, comprising the steps of:
(a) determining a desired pH value of an aqueous solution, an overall electric potential of the electrochemical cell, a solution volume and a differential between the surface areas of the positive and negative electrodes, by the equation:

pH=7×(1−n)+n×log[96485×V/(((([A⁻]−[A⁺])×n×ε/d)−C_{sd})×f×E)]

wherein:
V is the volume of the aqueous solution disposed within the device;
[A⁻] is the nominal surface area of the negative electrode;
[A⁺] is the nominal surface area of the positive electrode;
n is 1 when the negative electrode is the higher surface area electrode, or n is −1 when the positive electrode is the higher surface area electrode.
ε is the permittivity constant;
d is the distance between the surface adsorbed ions and the opposite charged electrode in an electrical double layer;
C_{sd} is the total self-discharge capacity of the high surface area electrode;
f is a normalizing factor; and
E is the overall electric potential of the electrochemical cell.
(b) determining a magnitude and time of an electrical current to be applied between the positive and negative electrodes by the equation:

pH=14+log[96485×V/(I×dt)],

wherein:
V is the volume of the aqueous solution disposed within the device;
I is the electric current applied between the electrodes; and
dt is the time interval for applying said electric current;
(c) introducing said aqueous solution into the electrochemical device at the calculated volume V of step (a);
(d) applying the electric current determined in step (b) between the electrodes, until the desired pH of the resulting solution is obtained.

In one embodiment of the invention the method further comprises the steps of:
(e) replenishing the volume of the solution in the device with the aqueous solution of step (c);
(f) reversing the polarization of the electrochemical cell device; and
(g) applying the electrical current between the reversed polarized electrodes, until the desired pH of the resulting solution is obtained.

In some embodiments of the above method, the total self-discharge capacity of the high surface area electrode is different than 0 (zero) and the high surface area electrode is surface-treated such that it is continuously self-discharged.

The above method can be used, in one embodiment, to produce a hypochlorous acid solution. According to one embodiment of the invention the concentration of the salt needed for obtaining a concentration C_{HOCl} of the hypochlorous acid is determined according to:

C_{NaCl}=(10^{-(7×(a-1)+pH}/V+C_{HOCl}×t/300

wherein:
C_{NaCl} is the required salt concentration in the solution disposed within the device, in Molar units (mole/Liter);
pH is the desired pH of the solution;
a is 1 when pH<7, or a is −1 when pH>7;
V is the volume of the solution disposed within the device;
C_{HOCl} is the desired concentration of the active material needed for a given application; and
t is the operating time of the device.

Further disclosed is a method for controlling the pH of a solution containing a chloride derivative, comprising applying a current to a device for generating an aqueous solution having a desired pH as described above until the desired pH is obtained.

### BRIEF DESCRIPTION OF THE DRAWINGS

In the drawings:

FIG. 1 is a schematic illustration of a two-compartment electrochemical cell having an ion-exchange membrane for producing electrolyzed water, according to the prior art;

FIG. 2 is a schematic illustration of a single-compartment electrochemical cell for producing alkaline electrolyzed water;

FIG. 3 is a schematic illustration of a single-compartment asymmetric electrochemical cell for producing acidic electrolyzed water, according to an embodiment of the present invention;

FIG. 4 is an equilibrium plot of available chlorine present as hypochlorous acid (% HOCl), as a function of pH;

FIG. 5 is a schematic illustration of a single-compartment asymmetric electrochemical cell for producing alkaline electrolyzed water, according to an embodiment of the present invention;

FIG. 6A provides a schematic side view of an electric sprayer operating according to the invention, having at least one high surface area electrode and having at least one low surface area electrode;

FIG. 6B provides a cross-section of the body of the electric sprayer of FIG. 6A;

FIG. 6C provides a schematic representation of an electrical diagram of an electrochemical device according to the invention, such as may be the electric sprayer of FIG. 6A;

FIG. 7 is a schematic representation of an electrochemical towelette, according to an embodiment of the present invention;

FIG. 8A provides a schematic, transparent top view of an electrochemical container, according to an embodiment of the present invention;

FIG. 8B provides a schematic, transparent side view of the electrochemical container of FIG. 8A.

FIG. 9A is a self-discharge plot, showing the decline of the potential (E, in volts) over time (T, in seconds), that was obtained by an activated carbon cloth electrode from Kynol type ACC-5092-15, versus a saturated calomel electrode (SCE) as a reference electrode.

FIG. 9B is the self-discharge plot of the FIG. 9A presenting the time scale as a logarithmic scale.

FIG. 10 is a plot of hypochlorous anion (OCl⁻) concentration in ppm as a function of the charge/discharge cycle number (#) under constant current, applied to an electrochemical towelette according to the invention, after wetting with tap water; in the Fig., (+) indicates that the low surface area electrode is positively charged, and (−) indicates that the low surface area electrode is negatively charged;

FIG. 11 is a plot of acidic pH development in a towelette such as that of FIG. 7 (low surface carbon side) as a function of time (charge/discharge cycle number, #);

FIG. 12 is a plot of the pH development in the towelette of FIG. 7, as a function of total charge consumption (in milliampere hour units, mAh), according to an embodiment of the present invention;

FIG. 13 is a plot of the pH development in the towelette of FIG. 7 (low surface area side) as a function of time (T, in seconds), according to another embodiment of the present invention; in the Fig., EC indicates end of charging;

FIG. 14 is a plot of potential (in Volts, V) vs. time (T, in seconds) for an electrochemical towelette such as described with reference to FIG. 7, according to still another embodiment of the present invention;

FIG. 15 is a plot of the pH development in the towelette of FIG. 7 (high surface area side) as a function of time (T, in seconds), according to yet another embodiment of the present invention;

FIG. 16 is a plot of the pH development in the towelette of FIG. 7 (low surface area side) as a function of time (T, in seconds), according to a further embodiment of the present invention;

FIG. 17A is a photograph of Escherichia coli colonies in Petri dishes, following treatment in the central area of the dishes, using a non-polarized (NP) electrochemical towelette and polarized (P) electrochemical towelette, such as described with reference to FIG. 7, for 24 hours;

FIG. 17B is a photographs of Staphylococcus aureus colonies in Petri dishes, following treatment in the central area of the dishes, using a non-polarized (NP) electrochemical towelette and polarized (P) electrochemical towelette, such as described with reference to FIG. 7, for 24 hours;

### DETAILED DESCRIPTION OF THE INVENTION

The asymmetric electrochemical cell device according to the invention addresses the need for an improved electrochemical device, which does not require an ion-exchange membrane and reduces the expenses necessary to produce the device, by using relatively inexpensive materials. In addition, the device according to the invention can maintain its functionality over time, by operating the device under conditions which prevent overusing the electrodes.

For the sake of simplicity, the salt solution exemplified throughout this description is a pure NaCl solution in water. However, as will be apparent to the skilled person, if other chemical entities are present in the solution (e.g., other salt traces), additional electrochemical reactions not shown in these simplified examples will take place, which are well understood to the skilled person and, therefore, are not discussed herein in detail for the sake of brevity.

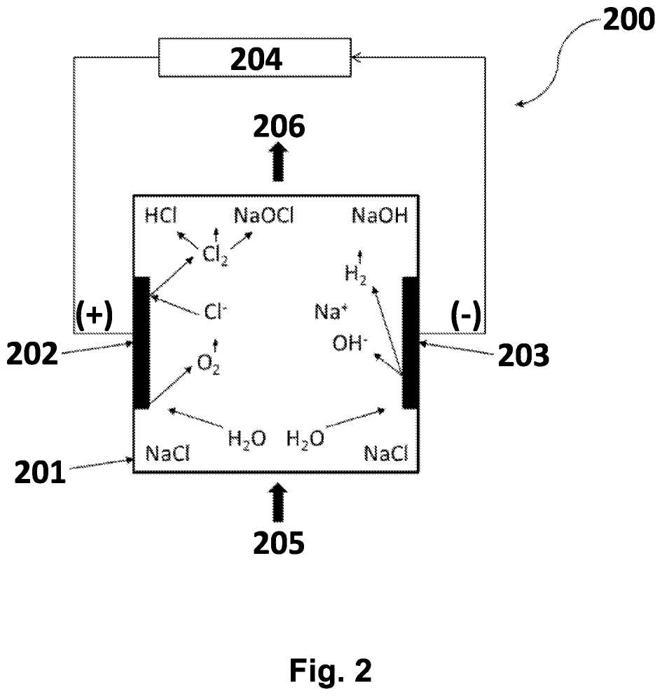

FIG. 2 provides a schematic illustration of a single-compartment electrochemical cell 200 for producing an alkaline water discharge 206. The single-compartment electrochemical cell 200 contains a cell housing 201 to which salt water (aqueous NaCl) feed 205 is introduced. When positive electrode (anode) 202 and negative electrode (cathode) 203 are electrically connected to a suitable power supply 204, the faradaic reactions which take place over the electrodes ultimately result in an alkaline solution containing an alkali hypohalite (e.g., sodium hypochlorite) and having a pH value of about 8-10.

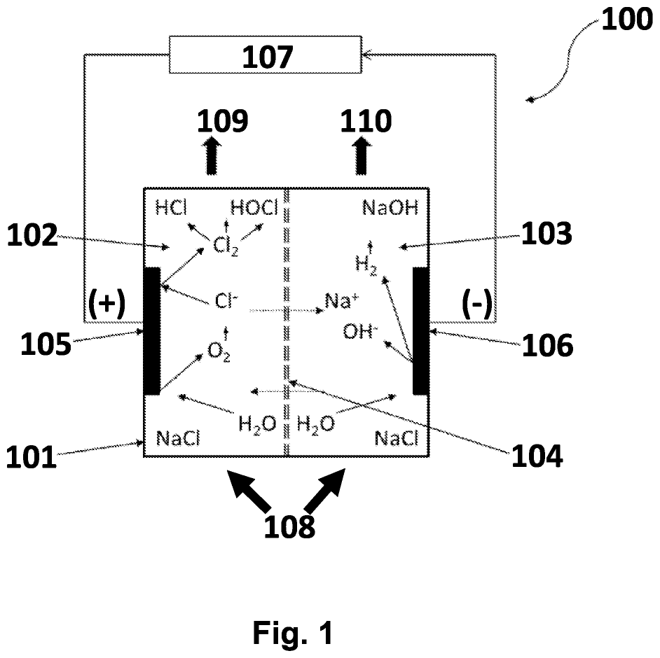

In one aspect, the present invention provides a device for generating a charged liquid, using an asymmetric electrochemical cell, having a structure similar to the electrochemical cell 100 of FIG. 1, and comprising a single-compartment cell housing (i.e., without and ion-exchange membrane), a power supply, at least one positive electrode and at least one negative electrode within the cell housing, wherein the surface area of one of the electrodes is higher than the surface are of the opposite charged electrode by a differential determined according to an appropriate equation selected from Equations 1, 5 and 6, as described hereinbelow.

It should be noted that in the asymmetric electrochemical cell device of the invention, the positive and/or negative electrode may physically comprise more than one electrode. Hence, the term “surface area” of an electrode as used herein refers to the sum of surface areas of all the electrodes which make the positive or negative electrode.

The asymmetric electrochemical cell device of the invention may advantageously be used to produce electrolyzed water at a desired pH.

According to the invention, control over the pH of the solution within the device can be achieved by using an asymmetric electrochemical cell so that, as hereinafter discussed, only one of the electrodes (i.e., the low surface area electrode) engages in chemical reactions involving faradaic charge transfer, namely, the low surface area electrode works in a “faradaic mode”. By contrast, the high surface area electrode is mainly acts as a capacitor to accumulate the electrical charge and adsorb opposite-charged ions in the electrolyte solution in its vicinity. Hence, the high surface area electrode works in a “capacitive mode” or “non-faradaic mode”.

The term “semi-capacitive electrochemical mode of operation” as used herein refers to applying a current between one electrode working in a faradaic mode and a second electrode working in a capacitive mode.

In order to achieve electrolyzed water having an acidic pH according to the present invention, the positive electrode should be the low surface area electrode while the negative electrode should be the high surface area electrode. In this mode of operation, hydrogen ions (H⁺) would be liberated from water being electrolyzed at the positive electrode, with little or no formation of hydroxide ions (OH⁻) at the negative electrode. Similarly, in order to achieve electrolyzed water having an alkaline pH according to the present invention, the negative electrode should be the low surface area electrode while the positive electrode should be the high surface area electrode. In this scenario, hydroxide ions (OH⁻) would be liberated from water being electrolyzed at the negative electrode, with little or no formation of hydrogen ions (H⁺) at the positive electrode.

However, in order for the device of the invention to be fully functional and have tight control over the pH of the electrolyzed solution, the differential between the surface areas of the positive and negative electrodes should be sufficient as to enable the high surface area electrode to keep accumulating the electrical charge until the desired pH of the solution is achieved by the faradaic reactions occurring at the opposite electrode. The dimensional requirements of the system according to the invention are set forth in equations 1, 5 and 6 below.

In order to achieve a functional asymmetric electrochemical cell device according to the invention, the following variables should be taken into account:
the pH value of the electrolyzed aqueous solution;
the overall electric potential of the electrochemical cell;
the volume of the aqueous solution disposed within the electrochemical cell; and
the electrochemical capacitance differential (D_{ec}) between the negative and positive electrodes, namely, the differential between nominal surface areas of the positive and negative electrodes.

The term “nominal surface area” as used herein refers to the surface area that allows the ions having a hydration layer to enter through its porous structure in m²/gr.

Equation 1 defines the dependence of the differential between the electrodes surface area, the overall electric potential of the cell and the volume of the aqueous solution on the maximal pH which the device may produce, when the negative electrode is the higher surface area electrode, as follows:

pH=log[96485×V//(((([A⁻]−[A⁺])×ε/d)−C_{sd})×f×E)] (1)

wherein:
V is the volume of the aqueous solution disposed within the device
[A⁻] is the nominal surface area of the negative electrode;
[A⁺] is the nominal surface area of the positive electrode;
ε is the permittivity constant;
d is the distance between the surface adsorbed ions and the electrode opposite charge in an electrical double layer;
C_{sd} is the total self-discharge capacity of the high surface area electrode;
f is a normalizing factor; and
E is the overall electric potential of the electrochemical cell.

It should be noted that the C_{sd} is dependent on the specific material used for the high surface area electrode. Accordingly, the value of C_{sd} should be determined for the specific electrode material used as the high surface area electrode in the device. Determining the value of C_{sd} can be carried out using any routine method for measuring the self-discharge capacity of an electrode.

The self-discharge of the electrolytic capacitor occurs via a passage of faradaic currents that can oxidize or reduce moieties in the electrolyte solution or in the electrode itself. The potential decline with time is expected to follow a certain behavior, according to the reaction rate. Whatever the nature of the reaction rate (e.g., the rate of activation- or diffusion-controlled reactions), the self-discharge potential-time derivative is expected to obey equation 2:

$$\frac{CdE}{dt} = I \qquad ( 2 )$$

wherein:
C is the double-layer capacitance;
dE/dt is the potential-time derivative; and
I is the current.

In particular, if the kinetics of the self-discharge are determined by an activation-controlled electrochemical reaction, equation 2 can be written as:

$$C ( \frac{dE}{dt} ) = {I}_{0} {e}^{( \frac{α EF}{RT} )} \qquad ( 3 )$$

wherein:
C is the double-layer capacitance;
dE/dt is the potential-time derivative;
I₀ is the exchange current;
R is the universal gas constant;
T is the cell temperature;
α is the transfer coefficient; and
F is the Faraday constant.

A plot of E vs. log(t) is expected to follow a linear decline after a certain plateau.

In order to calculate the C_{sd}, the different values of −C(dE/dt), which is potential and time dependent, should be summed according to equation 4:

$${C}_{sd} = {\sum }_{t = 0}^{{t}_{f}} C ( \frac{dE}{dt} ) \qquad ( 4 )$$

wherein:
C_{sd} is the self-discharge capacitance;
C is the double-layer capacitance;
dE/dt is the potential-time derivative;
t is the self-discharge time; and
t_{f} is the specific time that can be used to calculate the self-discharge capacitance for specific differential time and potential.

As would be appreciated by a person of skills in the art, every electrode has its own molecular structure, as well as specific physical and chemical properties, which during operation of the device of the invention may lead to a deviation from the values that can be theoretically determined by an equation. Therefore, Equation 1 includes a normalizing factor (f), which takes said deviations into consideration. The normalizing factor is the average ratio between a theoretical surface area and an experimental surface area of a specific electrode. The normalizing factor is unique for a specific combination of high surface area and low surface area electrodes. The normalizing factor is obtained by the following steps:
(1) conducting a set of at least three experiments, in which an asymmetrical electrochemical cell is operated, wherein the surface area of a first electrode is different at each experiment (designated “experimental surface area”), while the surface area of the a second electrode is constant through all experiments, as well as the volume and the content of the solution and the electric potential of the electrochemical cell;
(2) noting the resulting pH of the solution at the end of each separate experiment;
(3) determining a theoretical surface area of the first electrode according to Equation 1, using the resulting pH from the plurality of experiments, and wherein f equals 1;
(4) determining the ratio between the theoretical surface area and the experimental surface area of the first electrode for each pH obtained from a separate experiment; and
(5) averaging the ratios between the theoretical surface area and the experimental surface area of the first electrode for each of said resulting pHs, to obtain the normalizing factor for the specific combination of first and second electrodes as used in the experiment.

An example illustrating the determination of the normalizing factor is detailed in Example 1 below.

It should be noted that the first electrode may be the negative or the positive electrode, and the second electrode may be the positive or the negative electrode, respectively. In addition, the first electrode may be the high surface electrode or the low surface area electrode in the device of the invention, while the second electrode is the low surface area or the high surface area electrode, respectively.

It should also be noted that in time, the normalizing factor for a desired combination of electrodes to be used in an asymmetrical electrochemical cell device of the invention could be drawn from a known database of normalizing factors determined for various combinations of electrodes.

Equation 5 defines the dependence of the differential between the electrodes surface area, the overall electric potential of the cell and the volume of the aqueous solution on the maximal pH which the device may produce, when the positive electrode is the higher surface area electrode, as follows:

pH=14−log[96485×V/(((([A⁺]−[A⁻])×ε/d)−C_{sd})×f×E)] (5)

wherein:
V is the volume of the aqueous solution disposed within the device;
[A⁺] is the nominal surface area of the positive electrode;
[A⁻] is the nominal surface area of the negative electrode;
ε is the permittivity constant;
d is the distance between the surface adsorbed ions and the electrode opposite charge in an electrical double layer;
C_{sd} is the total self-discharge capacity of the high surface area electrode;
f is a normalizing factor; and
E is the overall electric potential of the electrochemical cell.

Alternatively, the dependence of the differential between the electrodes surface area, the overall electric potential of the cell and the volume of the aqueous solution on the maximal pH which the device may produce can be defined by a single Equation 6, as follows:

pH=7×(1−n)+n×log[96485×V/(((([A⁻]−[A⁺])×n×ε/d)−C_{sd})×f×E)] (6)

wherein:
V is the volume of the aqueous solution disposed within the device;
[A⁻] is the nominal surface area of the negative electrode;
[A⁺] is the nominal surface area of the positive electrode;
n is 1 when the negative electrode is the higher surface area electrode, or n is −1 when the positive electrode is the higher surface area electrode;
ε is the permittivity constant;
d is the distance between the surface adsorbed ions and the opposite charged electrode in an electrical double layer;
C_{sd} is the total self-discharge capacity of the high surface area electrode;
f is a normalizing factor; and
E is the overall electric potential of the electrochemical cell.

It should be appreciated that the lower the desired pH, and/or the higher the initial pH of the feed solution, the larger the D_{ec} is. Similarly, increasing the volume of the aqueous solution within the electrochemical cell may require a larger D_{ec}.

It should also be appreciated that the variables in Equations 1, 5 and 6 also depend on thermodynamic parameters, such as pressure and temperature.

It should be noted that the value of each of the variables in Equations 1, 5 and 6 can be extracted and calculated according to the suitable equation, when the other variables are known. For example, if a desired pH of a given aqueous solution at a given volume is to be achieved by operating the device of the invention at a given potential, then the differential between the surface areas of the positive and negative electrodes needed to achieve the desired pH can be calculated. In another example, if a desired pH of a given solution is to be achieved by operating a device according to the present invention at a given potential having a specific surface areas differential between the positive and negative electrodes, then the volume of the solution needed to be introduced into the device in order to achieve the desired pH can be calculated.

In some embodiments, the device of the invention requires solely one electrode (i.e., the low surface area electrode) to be resistive to electrolysis reactions. Hence, the low surface area electrode may be made of, or include, graphite sheets, carbon cloth, carbon paper, or titanium metallic sponge. For the high surface area electrode, relatively inexpensive materials such as activated carbon may advantageously be utilized. Moreover, the cell membrane used in prior art processes is obviated. Thus, the manufacture and/or maintenance cost of the device of the invention can be reduced relatively to the electrochemical cell described in the prior art.

In other embodiments, the electrochemical device of the invention may utilize a graphite electrode as the low surface area electrode, and an activated carbon sheet, or a graphite sheet coated with activated carbon, as the high surface area electrode.

Operating the device according to the invention comprises applying a current between the positive and negative electrodes in order to electrolyze the aqueous solution disposed within the device until the desired pH of the solution is achieved.

Equation 7 defines the dependence of the applied current, the time the current is applied and the volume of the aqueous solution disposed within the device of the invention on the pH value of the solution, as follows:

pH=log[96485×V/(I×dt)] (7)

wherein:
V is the volume of the aqueous solution disposed within the device;
I is the electric current applied between the electrodes; and
dt is the time interval for applying said electric current.

It should be noted that the variables in Equation 7 also depend on thermodynamic parameters, such as pressure and temperature.

It should be appreciated that the higher the current applied, less time is needed to reach the desired pH, and vice versa (in assumption that the current does not affect the capacitance). Therefore, in order to save time, a higher current (as given by Equation 7) can be applied between the electrodes in the device of the invention, so that the desired pH is achieved more rapidly. Alternatively, a lower current can be applied for a longer period of time (as given by Equation 7) in order to reach the desired pH of the solution, and thus extending the useful lifetime of the electrode and protecting it from damages which may occur through overuse.

It should be noted that the high surface area electrode can be easily regenerated by stripping off its accumulated charge.

In some embodiments of the invention, the regeneration of the high surface area electrode is continuous even during operation of the electrolysis device by using a high surface area electrode that is surface-treated, such that the electrode is continuously self-discharged. In a specific exemplary embodiment of the invention, treating the surface of the electrode comprises grounding the electrode. In another specific embodiment, treating the surface of the electrode comprises addition of oxide functional groups to the surface of the electrode.

As can be appreciated by a skilled person in the art, the addition of oxide functional groups to the surface of the high surface electrode provides a counter charge to that of the polarized electrode, so that said polarized electrode exhibits enhanced self-discharge due to faradaic and electrostatic interactions, without any external intervention.

The terms “oxide functional groups” and “oxygen-containing functional groups”, as used interchangeably herein, refer to alcohols, ethers, aldehydes, ketones, and carboxylic acids, as well as to a variety of derivatives of the carboxylic acids, such as amides, esters, and acid halides. Non-limiting examples of oxide functional groups are carboxyl, lactone, lactol, phenol, ketone, carbonyl, and quinone groups.

Accordingly, the term “surface-treated high surface area electrode” as used herein refers to a high surface area electrode that is grounded and/or comprises oxide functional groups.

As would be appreciated by a person skilled in the art, when the electrode is not self-discharged, the value of C_{sd} is 0 (zero). However, when a surface-treated electrode is used in the device, the value of C_{sd} is different than 0 (zero) and the total charge capacity gained by the enhanced self-discharge (C_{sd}) of said electrode, both in steady state and under application of a current density, is significantly improved and may strive to infinity.

In another aspect, the present invention provides a method of operation of an asymmetric electrochemical cell device comprising the following steps:
(a) determining the values of the variables necessary for a functional operation of the device, namely, a desired pH value of the aqueous solution, an overall electric potential of the electrochemical cell, a solution volume disposed within the electrochemical cell and an electrochemical capacitance differential (D_{ec}) between the negative and positive electrodes (i.e., a differential between the surface areas of the positive and negative electrodes) by the appropriate equation selected from Equation 1, 5 and 6.
(b) determining a magnitude and time of an electrical current to be applied between the positive and negative electrodes by Equation 7.
(c) introducing an aqueous solution into the electrochemical device at the calculated volume V of steps (a) and (b);
(d) applying the electric current calculated in step (b) between the electrodes, until the desired pH of the resulting solution is obtained.

An illustrative overall electric potential of the electrochemical cell is externally applied between 40-50 mV/(cm² of the geometric area of the low surface area electrode) by a power supply, and an illustrative current applied between the electrodes has a magnitude of up to 10 mA/(cm² of the geometric area of the low surface area electrode). The “geometric” area (i.e., the area that is observed by a naked eye) is the total area of the electrode, which may differ from the effective surface area, if part of the geometric area does not effectively participate in the process. These values should not be taken as in any way limiting of the invention, and they are provided solely to illustrate possible suitable ranges.

The pH of a solution can be usefully changed in a very broad range by operating the device according to the invention. For instance, in a specific embodiment of the invention, the desired pH of the aqueous solution is within the range of 4-6, while in another specific embodiment of the invention, the desired pH of the aqueous solution is at least 10. The desired pH is dependent on the intended use, as will be easily apparent to the skilled person.

In some embodiments, the device of the invention may be operated in two stages such that, in a first stage, the high surface area electrode operating in a capacitive mode is negatively charged, while the low surface area electrode operation in a faradic mode is positively charges, and in a second stage, the polarity is reversed, such that the high surface area electrode is now positively charged and the low surface area electrode is now negatively charged. According to this embodiment, the first stage provides an acidic pH, while the second stage produces alkaline electrolyzed water, and of course operation can be conducted vice versa.

According to one embodiment, the method of operation of the asymmetric electrochemical cell device of the invention may also comprise the steps of:
(e) replenishing the volume of the solution in the device with the aqueous solution of step (c);
(f) reversing the polarization of the electrochemical cell device; and
(g) applying the electrical current between the reversed polarized electrodes, until the desired pH of the resulting solution is obtained.

In some embodiments of the invention, the high surface area electrode can be regenerated after the operation of the device is complete, by drying it after rinsing out the concentrated solution with water, e.g., tap water (to avoid fouling reactions). When the high surface electrode is dry, the adsorbed counter ions are released, thereby reducing the electric charge on the surface of the electrode.

As would be appreciated by a person skilled in the art, when the C_{sd} of the high surface electrode is 0 (zero), regenerating the electrode by rinsing the electrode with water and drying it is required between operations of the device.

In other embodiments, the regeneration of the high surface area electrode is continuous even during operation of the device by using a surface-treated electrode as the high surface area electrode, such that the electrode is continuously self-discharged. Therefore, the C_{sd} of the high surface electrode is different from 0 (zero). For example, the surface-treated electrode may be a grounded electrode or an electrode comprising oxide functional groups on its surface, as described hereinabove.

It should be noted that the surface-treated electrode can also be regenerated by rinsing the electrode with water and drying it, as described above.

In yet another aspect, the present invention provides an electrochemical method for producing hypohalous acid (HOX) in an aqueous solution using an asymmetric electrochemical cell device operated by steps (a)-(d) as described hereinbefore.

According to the present invention, the aqueous solution contains:
(I) alkali metal cations (M⁺); and
(II) (II) halogen anions (X⁻) corresponding to the hypohalous acid, and said device comprises a negative electrode and a positive electrode immersed in the aqueous solution.

In addition, the negative electrode has a higher surface area than the positive electrode, at a differential obtained by Equation 1 or Equation 6, such that applying the electric current of step (b), according to the method of operation of the asymmetric electrochemical cell device, between the positive and negative electrodes results in:
(i) adsorption of said alkali metal cations on the surface of the negative electrode; and
(ii) production of a solution containing hypohalous acid and hydrogen ions (H+), wherein the hypohalous acid is formed from halogen anions through a set of faradaic reactions at the positive electrode, followed by a disproportionation reaction of the hypohalous acid.

In a specific embodiment of the invention, the solution containing hypohalous acid has a slightly acidic pH within the range of 4-6, which favors maintaining a high concentration of the hypohalous acid in the solution. Namely, at pH of 4-6 more than 90% of the halogen in the solution is in the form of hypohalous acid instead of in the form of hypohalite or halogen such as I₂, Br₂, Cl₂ or F₂.

Reference will now be made to several detailed embodiments of the present invention, examples of which are illustrated in the accompanying figures. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures illustrated herein may be employed without departing from the principles of the invention described herein.

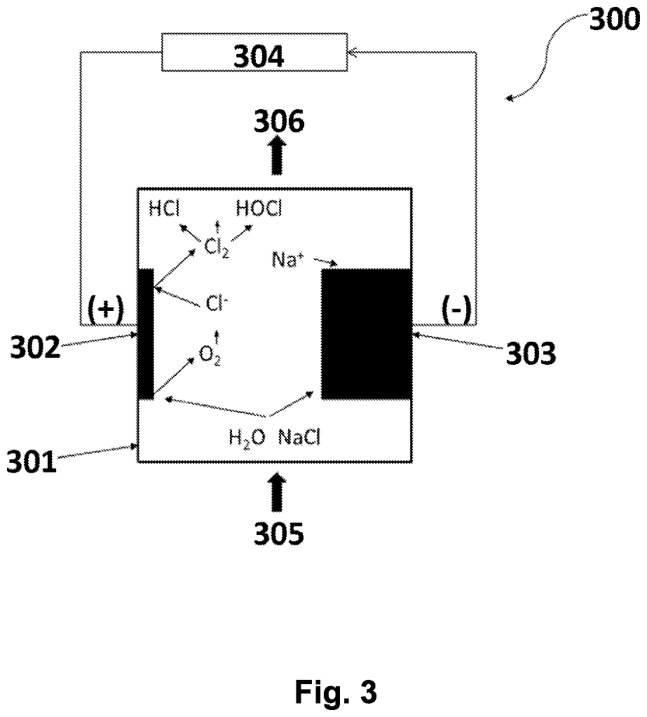

FIG. 3 is a schematic illustration of an asymmetric, typically single-compartment electrochemical cell 300 for producing an acidic water discharge 306, according to one embodiment of the invention. The asymmetric electrochemical cell 300 includes a cell housing 301 adapted to contain at least one positive electrode 302 and at least one negative electrode 303 having a higher surface area than the positive electrode 302. The differential between the surface areas of the positive and negative electrodes can be obtained by Equation 1 or Equation 6. An electrical circuit is formed when the positive electrode 302 and negative electrode 303 are immersed within water or aqueous solution disposed within the cell housing 301 and electrically connected to a suitable power supply 304.

The feed or operating solution 305 introduced to the asymmetric electrochemical cell 300 contains an alkali halide solute, typically Na⁺ or K⁺, and chloride (Cl⁻).

The asymmetric electrochemical cell 300, may advantageously be used to produce electrolyzed water having an acidic pH.

In still another aspect, the present invention provides a method for controlling the pH of a solution containing a chloride derivative, comprising applying a current to a device for generating an aqueous solution having a desired pH of the invention, as described hereinabove, until the desired pH is obtained.

In a specific embodiment of the invention, the hypohalous acid produced by the asymmetric electrochemical cell device 300 is hypochlorous acid (HOCl). The method for producing a hypochlorous acid solution comprises asymmetrically electrolyzing and aqueous solution comprising NaCl (salt water, aqueous NaCl) under the correct conditions as determined by Equations 1, 5 and 6. The resulting hypochlorous acid solution can be used as a disinfectant due to the bactericidal (anti-microbial) activity of hypochlorous acid. During the operation of the device of the invention, H₂0 and NaCl are electrolyzed to liberate O₂ and Cl₂ at the positive electrode, Cl₂ being a reactant in the disproportionation reaction of hypochlorous acid which can subsequently occur. The high surface area of the negative electrode adsorbs Na⁺ ions with little or no formation of hydroxide ions (OH⁻). Therefore, due to the asymmetry of the device of the invention, the resulting solution has an acidic pH. However, the pH of the resulting solution may affect the concentration of hypochlorous acid in the solution. A very low pH (i.e., pH<4) drives the disproportionation reaction of hypochlorous acid, namely Cl₂+H₂0 [symbol] HCl+HOCl, to the left, thereby leading to a reduction in hypochlorous acid concentrations and the formation of dissolved chlorine gas, which can damage the components of the device (such as the electrodes in the device) by corrosion. Therefore, in order to reach an effective solution having high concentration (more than 70%) of hypochlorous acid and minimal concentrations of corrosive chlorine gas, the operation of the device of the invention should be stabilized when the pH of the solution is only slightly acidic, namely having a pH value within the range of 4-6.

It should be noted that the prior art teaches away from the instant invention. For instance, WO 2017/064577 teaches to use a hypochlorous acid solution having a pH in the range of 2-4 as an effective disinfectant solution. However, it has been found that this range is less effective that the 4-6 pH range according to the present invention. Moreover, stabilizing the device of the present invention at a slightly acidic pH of 4-6 prevents the formation of corrosive chlorine gas, and thereby prolongs the useful life of the device and reduces maintenance costs.

WO 2017/064577 also teaches to operate the asymmetric electrochemical cell apparatus by applying two currents between the electrodes so that the amount of hypochlorous acid is replenished. It has been found that, according to the present invention, a single current is conveniently applied between the positive and negative electrodes, which is sufficient for producing an effective hypochlorous acid solution.

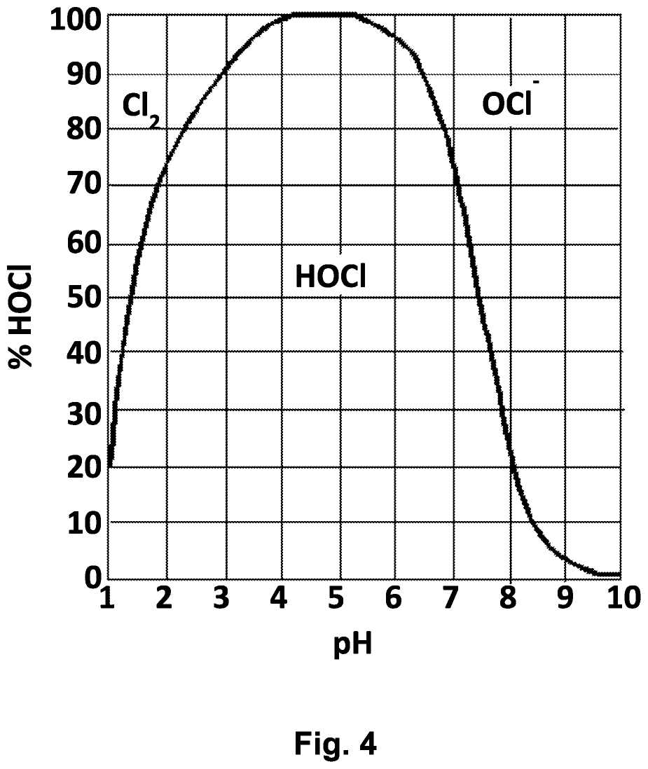

FIG. 4 is an equilibrium plot of available chlorine present as hypochlorous acid (HOCl), as a function of pH. As shown in FIG. 4, the concentration of hypochlorous acid is the highest (more than 90%) and most stable when the pH is within a range of 4 to 5.5. At pH 2, only about 70% of the chlorine in the system exists as hypochlorous acid, with the remaining 30% existing as active chlorine. It is thus evident that HOCl is not stable in acidic media, and it is more effectively used in a slightly acidic pH at a range of 4-6.

It should be noted that sodium hypochlorite (NaOCl) solution such as the common “bleach”, contain only about 5% hypochlorous acid, the remaining 95% being hypochlorite anion (OCl⁻). OCl⁻ has a very low bactericidal activity, 80-120 time less than hypochlorous acid. Hence, the hypochlorous solution at a slightly acidic pH of 4-6 is more effective as a disinfectant solution than a solution at a very acidic pH (pH<4) or bleach.

According to an embodiment of the invention, the concentration of salt needed for obtaining a desired concentration of hypochlorous acid (C_{HOCl}) is determined by Equation 8, as follows:

C_{NaCl}=(10^{-(7×(a-1)+pH}/V)+C_{HOCl}×t/300 (8)

wherein:
C_{NaCl} is the required salt concentration in the solution disposed within the device, in Molar units (mole/Liter);
pH is the desired pH of the solution;
a is 1 when pH<7, or a is −1 when pH>7;
V is the volume of the solution disposed within the device (Liter);
C_{HOCl} is the desired concentration of the active material needed for a given application, which, of course, will vary for different uses (Molar); and
t is the operating time of the device (sec).

Illustrative examples of C_{NaCl} are as follows:
1. When using the method for hand wash, the use of 10 to 50 ppm of HOCl active material will be required. If used for hospitals it is recommended to use 50 ppm, but for home use even 10 ppm will be sufficient.
2. If the application is for hospitals floor, bed and sheet cleaning, it is recommended to use 200 ppm.
3. To clean grains with the method of the invention, it is recommended to use 200 ppm.
4. When cleaning leaves such as lettuce in agriculture, the use of 20 to 100 ppm is recommended, depending on the type of leaves.

In a specific embodiment of the invention, the aqueous NaCl may consist of tap water, which contains at least 150 ppm alkali halide solute. Alternatively, water containing 0-150 ppm alkali halide solute (e.g., distilled water or deionized water) may also be used, followed by an addition of a portion of alkali halide salt such as table salt (NaCl). Alternatively, a pre-prepared solution of the alkali halide may be introduced. It should be appreciated that the alkali halide may be introduced to device of the invention in the form of a tablet or capsule, or in the form of a powder. It will be further appreciated that detergents, odorants, and other functional materials may be incorporated into the consumable salt.

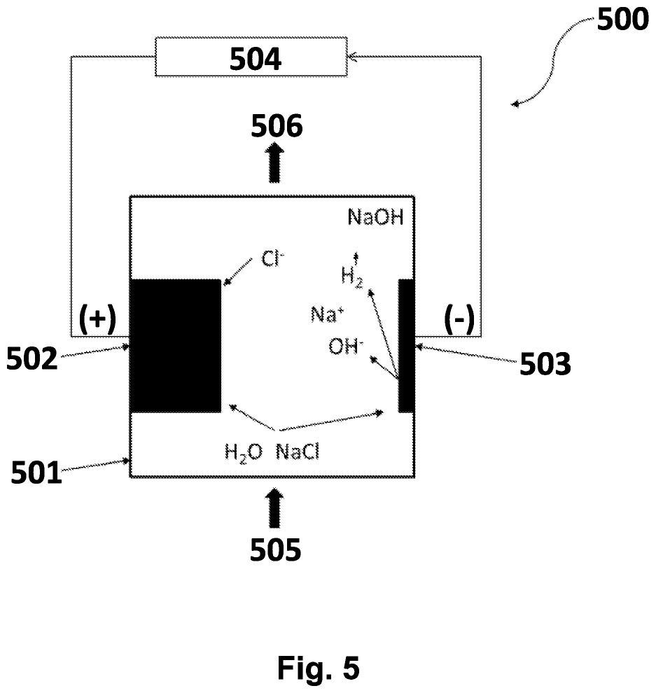

According to another embodiment of the invention, FIG. 5 is a schematic illustration of an asymmetric, single-compartment electrochemical cell 500 for producing an alkaline water discharge 506. Similar to the asymmetric electrochemical cell 300 of FIG. 3, the asymmetric electrochemical cell 500 includes a cell housing 501, at least one positive electrode 502 and at least one negative electrode 503, the positive electrode 502 has a higher surface area than the negative electrode 503 by a differential calculated by Equation 5 or Equation 6. When the positive electrode 502 and negative electrode 503, which are immersed within water or aqueous solution disposed within the cell housing 501 are and electrically connected to a suitable power supply 504, an electrical circuit is formed. The feed or operating solution 505 introduced to the asymmetric electrochemical cell 500 contains an alkali halide solute, typically Na⁺ or K⁺, and chloride (Cl⁻).

In a specific embodiment of the invention, the asymmetric electrochemical cell 500 may advantageously be used to produce electrolyzed water having an alkaline pH, for example, a pH value of at least 10. Electrolyzed water at such an elevated pH is particularly efficacious in removing chemical materials that are sensitive to high pH, for instance in degreasing applications and in removing pesticides from goods and produce. During the operation of the device of the invention, H₂0 and NaCl are electrolyzed to liberate H₂ and OH⁻ at the negative electrode. The high surface area of the positive electrode adsorbs Cl⁻ ions with little or no formation of hydrogen ions (H⁺).

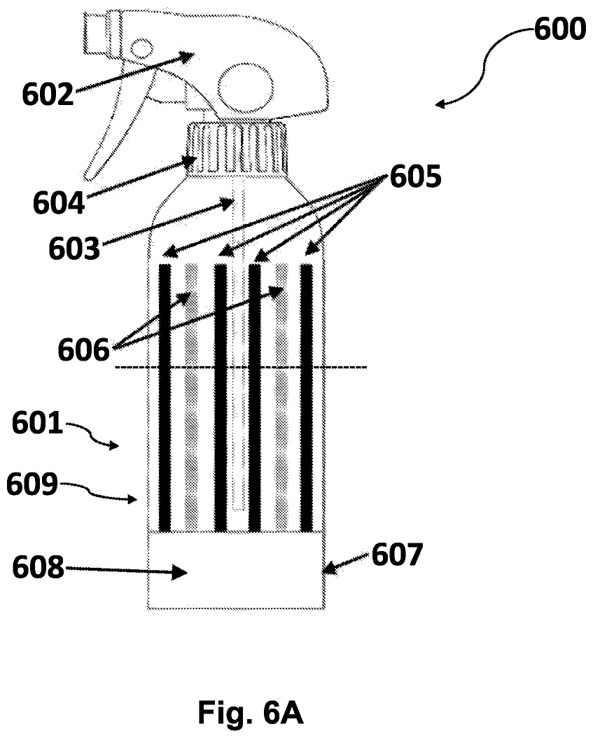

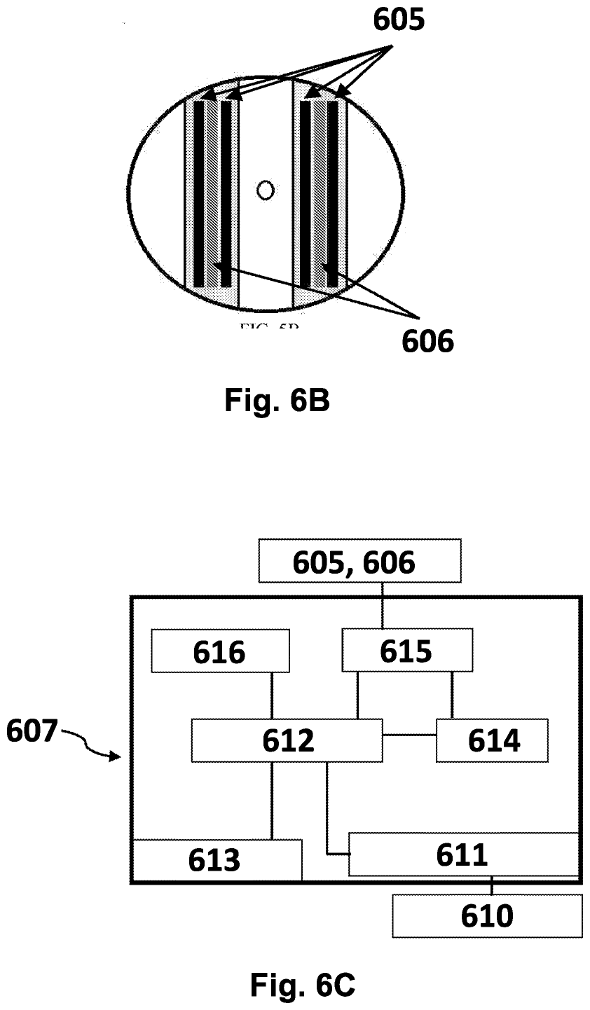

FIG. 6A is a schematic, transparent side view of an electrochemical device or sprayer 600 manufactured according to the present invention, that may include a vessel or bottle 601 (corresponding to cell housing 301 and 501 of FIGS. 3 and 4, respectively), and a spray head 602 connected to an immersion tube 603. Spray head 602 may be attached or secured to bottle 601 in various ways, typically by a threaded element 604 that screws on to a threaded neck (not shown) of bottle 601. Within bottle 601 are disposed at least one high surface area electrode 605 and at least one low surface area electrode 606. Electrodes 605 and 606 may be arranged as sheets, typically substantially parallel sheets, disposed in a vertical orientation with respect to the side of bottle 601. Such an exemplary arrangement is shown in the cross-sectional representation of bottle 601, provided in FIG. 6B.

The electronics or electronics unit 607 of inventive electrochemical device or sprayer 600 may be housed in a separate compartment 608 at the bottom of bottle 601, fluidly sealed from a liquid-containing volume 609 of bottle 601.

A schematic exemplary electrical diagram of the electronics 607 of electrochemical device or sprayer 600 is provided in FIG. 6C. In one embodiment, a power source 610, which is typically disposed externally to sprayer 600, may connect to the electronics 607 of sprayer 600 via a power source port 611, e.g., a universal serial bus (USB) connection. The electronics 607 typically include an internal power supply 612, which in some embodiments, is electrically connected to an on-board battery 613 via a battery housing. The internal power supply 612 may be responsive to a processing unit, such as central processing unit (CPU) 614, which is typically equipped with an internal memory, but alternatively or additionally, may communicate with an external memory. At least one switch 615, electrically connected to electrodes 605 and 606, may be responsive to CPU 614, for example to turn the current to the electrodes on or off. In some embodiments, switch 615 may be manually operated. A display 616 may also be responsive to CPU 614. In some embodiments, display 616 may have a first indicator, e.g., a light-emitting diode (LED) light for indicating that the cell is operating, and a second indicator for indicating that the desired pH has been obtained, such that the solution produced is ready for consumption.

Electrochemical sprayer 600 may be operated as described hereinabove, with reference to the electrochemical cell in general.

The method of operation of a device of the invention according to one embodiment is now described in more detail, and in exemplary fashion. A power source is connected to the device, e.g., via a USB cable. When connection is made, a voltage of up to about 5 V, a current of up to about 900 mA, or power of between 1.5-7.5 watts (depending on the USB standard type, such as USB 2.0 or USB 3.0), may be applied between the high surface area electrodes and the low surface area electrodes. The high surface area electrodes are negatively polarized and electrostatically filled with counter ions (e.g., Na⁺ and/or K⁺). The low surface area electrodes are positively polarized and create electrochemical interactions with the solution, which result in the production of hypochlorous acid and hydrochloric acid. The pH may be determined by, or strongly influenced by, the surface area of the high surface area electrodes with respect to the low surface area electrodes (or more precisely, the electrochemical capacitance of the high surface area electrodes with respect to the electrochemical capacitance of the low surface area electrodes), the solution volume, and the cumulative charge applied. Using a particular differential between the surface areas of the positive and negative electrodes (as determined according to Equation 1 or Equation 6) and a particular solution volume, and by charging to the maximum electrochemical capacitance of the high surface area electrodes, the cell can be constrained to produce the hypohalous acid around a particular or predetermined desired pH.

After the electrochemical sprayer is connected to the power source, e.g., for up to 30 seconds, a slightly acidic pH environment (e.g., a pH of 5) is achieved, and the solution produced contains concentrated hypochlorous acid. The on-board CPU may be adapted to control the display (e.g., to activate the green light) after calculating the cumulative charge consumption.

The CPU may be advantageously adapted to count the cumulative charge delivered between the electrodes over the time period of the operative mode (ΔQ), for example, using Equation 9, as follows:

ΔQ=V×F×(10^{-pH(desired)}−10^{-pH(initial)}) (9)

wherein:
F is the Faraday constant; and
V is the volume of the solution.

Once the volume of the solution decreases, the voltage will tend to increase (due to a decrease in the nominal surface area of the electrode). Hence, the CPU may be advantageously further adapted to control the magnitude of the current according to the volume of the solution, such that the voltage does not exceed an undesired or otherwise predetermined value.

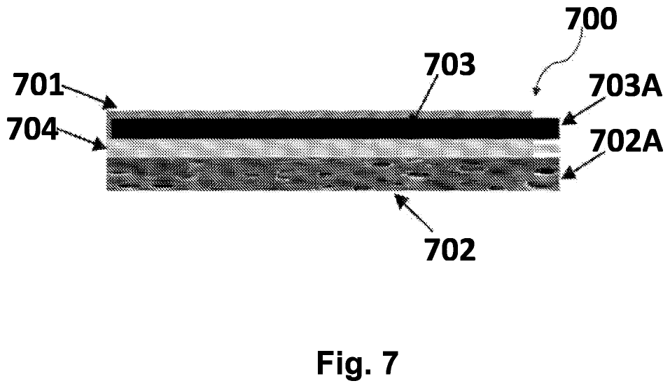

FIG. 7 is a schematic cross-section of an electrochemical cell towelette 700, according to an embodiment of the present invention. While the description relates to sodium chloride in exemplary fashion, it will be appreciated that any alkali halide, or mixture thereof, can be used. Electrochemical towelette 700, which includes at least one asymmetric electrochemical cell, may have at least one high surface area “counter” electrode 702 and at least one low surface area “working” electrode 703, separated by an insulating layer or sheet 704. Electrodes 702 and 703 may be arranged as parallel sheets. High surface area electrode 702 may be made of, or include, activated carbon (e.g., carbon cloth). Low surface area electrode 703 may be made of, or include, graphite sheets, carbon cloth, carbon paper, or titanium metallic sponge. Electrodes 702 and 703 may have tabs or protrusions 702A, 703A that facilitate electrical connection to a power supply such as a battery (not shown). Working electrode 703 may be wrapped or covered by a cloth 701, so as to avoid mechanical abrasion on working electrode 702.

In one exemplary electrochemical towelette of the present invention, a commercial carbon cloth (El-Gad, Israel) was used as the low surface area electrode 703, and a carbon cloth, having a specific surface area of about 1500 m²/g (Kynol, Japan) was used as the high surface area electrode 702. Such carbon cloth materials are made of carbon fibers.

In order to prepare the towelette for use, electrochemical towelette 700 may be submerged in tap water, using the limited amount of NaCl (or other alkali halide) therein (typically at least 150 ppm) to form the necessary reactive reagents. Upon polarization of the electrochemical towelette up to 5 Volts, low surface area electrode 703 undergoes faradaic reactions, whereas high surface area electrode 702 adsorbs counter ions by electrostatic interactions in a capacitive mode of operation. The pH and the concentration of the hypochlorous acid thus formed can be controlled by changing the appropriate variable according to an appropriate equation selected from Equation 1 and 5-7.

HOCl may react with organic contaminants present in the water. Some of the products could conceivably be harmful. However, by wetting the towelette through the high surface area carbon side, such organic contaminants may be adsorbed or removed, so as to appreciably reduce any concentration of organic contaminants in the electrolyzed water. Moreover, any amount of organic contaminants produced should be very small, because tap water is used, and this is coupled with the fact that only a very small amount of water per operation is used.

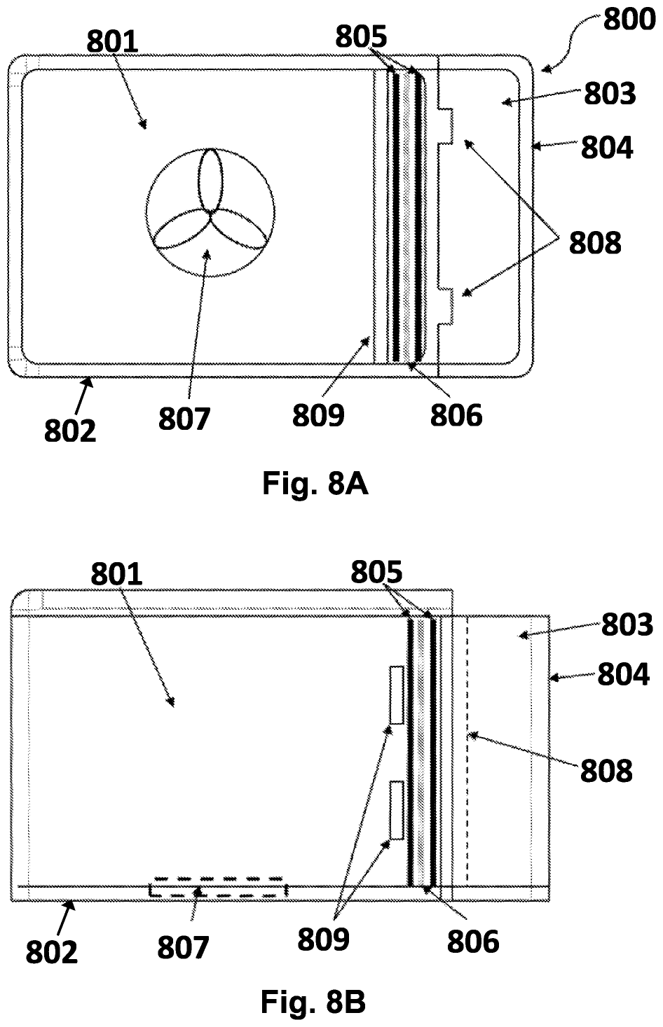

FIG. 8A provides a schematic, transparent top view of an asymmetric electrochemical container 800, according to an embodiment of the present invention. FIG. 8B provides a schematic, transparent side view of said container.

Electrochemical container 800 comprises a pool compartment 801, generally defined by a pool casing 802, and an electronics unit 803, generally defined by an electronics casing 804, and typically disposed at the side of pool compartment 801. It will be appreciated that the electronics casing 804 may be distinct and fluidly sealed with respect to the liquid contents within pool casing 802. Electrochemical container 800 also contains at least one high surface area electrode 805 and at least one low surface area electrode 806. Electrodes 805 and 806 may be arranged as sheets, typically substantially parallel sheets, disposed in a vertical orientation with respect to the side of the electrochemical container 800.

Electronics unit 803 of inventive electrochemical container 800 typically includes a CPU and associated memory, at least one switch or switching mechanism, a power supply, a display, and a power source port, and may be substantially identical to the electronics unit 607 provided in FIG. 6C and described hereinabove. In some embodiments, however, a battery may be unnecessary.

Within pool compartment 801 a stirring mechanism 807 may be disposed, which is typically anchored in a bottom surface of pool compartment 801. Stirring mechanism 807, which may be adapted to obtain a substantially homogeneous mixture of active product in the aqueous solution within pool compartment 801, may be electrically connected to, and powered by electronics unit 803.

A casing wall 808 of electronics unit 803, disposed between electronics unit 803 and pool compartment 801, may be used to secure the electronics (e.g., disposed on an electric board) in place, for example, using screws or other securing hardware. A casing component such as partition 809 may be used to hold the electrodes in place, and may have ports or holes to facilitate the transport of fluid in the vicinity of the electrodes.

Electrochemical container 800 may be operated substantially as described hereinabove, particularly with respect to the method of operation of the device of the invention.

According to a specific embodiment, the CPU of electrochemical container 800 may reverse the polarity in the electrochemical device (whenever reversed polarization is desired), for example, by controlling a switching mechanism associated with the electrodes and/or the power supply. The inventive electrochemical container 800 may be useful for a two-stage treatment of agriculture produce, wherein the first stage comprises the production of a slightly acidic hypochlorous acid solution at a pH of 4-6 for removing remaining living bacteria from the produce, and the second stage comprises the production of an alkaline solution at a pH of at least 10 for removing residual pesticides from the produce, or vice versa.

The hypochlorous acid solution produced by the electrochemical device of the present invention may be particularly efficacious in the treatment and disinfection of filters in water flow paths and water treatment devices. Such filters are known to encourage biofilm formation. Moreover, treating the filters with low pH solutions, as described herein, may also appreciably enhance the removal of scale and the like, which, in turn, yet further enhances removal of the biofilm.

In a specific embodiment, the solution produced by the asymmetric electrochemical cell device according to the invention may be used for treating agriculture produce, such as fruits and vegetables, for both disinfecting remaining living bacteria and removing residual pesticides from the surface of the produce.

The term “electrochemical capacitance” with respect to an electrode, as used herein, is generally defined by Equation 10, as follows:

Cd=dQ/dE (10)

wherein:
Cd is the differential electrochemical capacitance (in F);
dQ is the differential charge (in coulombs); and
dE is the differential potential (in Volts) of the electrode with respect to reference electrode.

Alternatively, equation 10 can be expressed as:

Cd=dQ/(dE*G) (10a)

wherein G is the electrodes weight (g) and Cd is the weight normalized differential electrochemical capacitance (in F/g).

Quantitative measurement of “electrochemical capacitance” is performed by cyclic voltammetry, as is known to those of skill in the art. Briefly, in cyclic voltammetry, the potential of the electrode (with respect to a reference electrode) is linearly scanned (usually starting from the initial immersion potential, which may be denoted as potential of zero charge (PZC) back and forth. The output is the current (vertical axis) versus the potential. Since the scan rate dE/dt (t is time) is constant and the current (I) equals dQ/dt, dividing the current values from the vertical axis by the scan rate value provides the differential capacitance (Cd) with respect to the potential (i.e., Cd(E)).

The term “portable” with respect to an electrochemical device or cell, as used herein, refers to a device or cell that can be freely carried, or freely moved around, by a user, while functioning in an operative, electrochemical mode using an on-board or other cordless power supply.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In addition, any citation or identification of any reference in this application shall not be construed as an admission that such reference is available as prior art to the present invention.

The invention will now be described with reference to specific examples and materials. The following examples are representative of techniques employed by the inventors in carrying out aspects of the present invention. It should be appreciated that while these techniques are exemplary of specific embodiments for the practice of the invention, those of skill in the art, in light of the present disclosure, will recognize that numerous modifications can be made without departing from the spirit and intended scope of the invention.

### EXAMPLES

### Example 1

### Determining the Normalizing Factor for a Combination of Electrodes

A set of three experiments was conducted, wherein the positive electrode is the low surface area electrode, having a surface area of 0.01 m², the solution volume was 2 Liter, the electrochemical cell was polarized at 5 Volts and the self-discharge capacity (C_{sd}) is 0 (zero). The experimental surface area of the negative electrode (being the high surface area electrode) in the set of experiments was 500, 1000 and 1500 m².

The resulting pH of the solution using each of the three experimental surface area of the negative electrode are shown in Table 1.

TABLE 1
Resulting pH depending on experimental
surface are of the negative electrode

| | Experimental surface area (m²) | | |
|---|---|---|---|
| | 500 | 1000 | 1500 |
| pH | 2.74 | 2.43 | 2.26 |

Table 2 shows the determination of the theoretical surface area of the negative electrode according to Equation 1 wherein f is 1, namely according to the following equation: pH=log[96485×V/(((([A⁻]−0.01)×ε/d)−C_{sd})×1×5)].

TABLE 2
Theoretical surface area of the negative electrode depending on pH

| | pH | | |
|---|---|---|---|
| | 2.74 | 2.43 | 2.26 |
| Theoretical surface area (m²) | 96 | 201 | 300 |

The ratio between the theoretical surface area and the experimental surface area of the negative electrode determined for each experiment is shown is Table 3.

TABLE 3
The ratio between the theoretical and experimental
surface area of the negative electrode

| | | | |
|---|---|---|---|
| Theoretical surface area (m²) | 96 | 201 | 300 |
| Experimental surface area (m²) | 500 | 1000 | 1500 |
| The ratio | 0.192 | 0.201 | 0.2 |

The average of the three ratios shown in Table 3 is 0.198. Hence, the normalizing factor (f) for the combination of electrodes as used in the experiments is 0.198.

### Example 2

### Determination of the Differential Between the Surface Areas of the Electrodes to Obtain a Slightly Acidic pH

The surface area differential necessary to obtain a pH of 5 in an aqueous solution is calculated by Equation 6: pH=7×(1−n)+n×log[96485×V/(((([A⁻]−[A⁺])×n×ε/d)−C_{sd})×f×E)]. The values of the variables in the equation were as follows:
V (volume of the aqueous solution)=2 Liter;
[A⁻] (nominal surface area of the negative electrode)=6.4 m²/gr;
[A⁺] (nominal surface area of the positive electrode)=0.01 m²/gr;
n is 1 when the negative electrode is the higher surface area electrode;
ε (permittivity constant)=˜80.1 (water permittivity)×8.854×10⁻¹² (vacuum permittivity);
d (distance in an electrical double layer)=˜10⁻⁹;
C_{sd} (total self-discharge capacity) is 0 (zero);
f (normalizing factor)=˜0.085, when using Activated carbon of Kynol type ACC-5092-15 (as the negative electrode) against graphite electrode (as the positive electrode); and
E (overall electric potential)=5 Volt;

The resulting pH of the solution is approximately 5.

### Example 3

### Determination of the Differential Between the Surface Areas of the Electrodes to Obtain an Alkaline pH

The surface area differential necessary to obtain a pH of 10 in an aqueous solution is calculated by Equation 6: pH=7×(1−n)+n×log[96485×V/(((([A⁻]−[A⁺])×n×ε/d)−C_{sd})×f×E)]. The values of the variables in the equation were as follows:
V (volume of the aqueous solution)=2 Liter;
[A⁻] (nominal surface area of the negative electrode)=0.01 m²/gr;
[A⁺] (nominal surface area of the positive electrode)=65 m²/gr;
n is −1 when the positive electrode is the higher surface area electrode;
ε (permittivity constant)=˜80.1 (water permittivity)×8.854×10⁻¹² (vacuum permittivity);
d (distance in an electrical double layer)=˜10⁻⁹;
C_{sd} (total self-discharge capacity) is 0 (zero);
f (normalizing factor)=˜0.085, when using Activated carbon of Kynol type ACC-5092-15 (as the positive electrode) against graphite electrode (as the negative electrode); and
E (overall electric potential)=5 Volt;

The resulting pH of the solution is approximately 10.

### Example 4

### Determination of the Self-Discharge Capacity and Rate

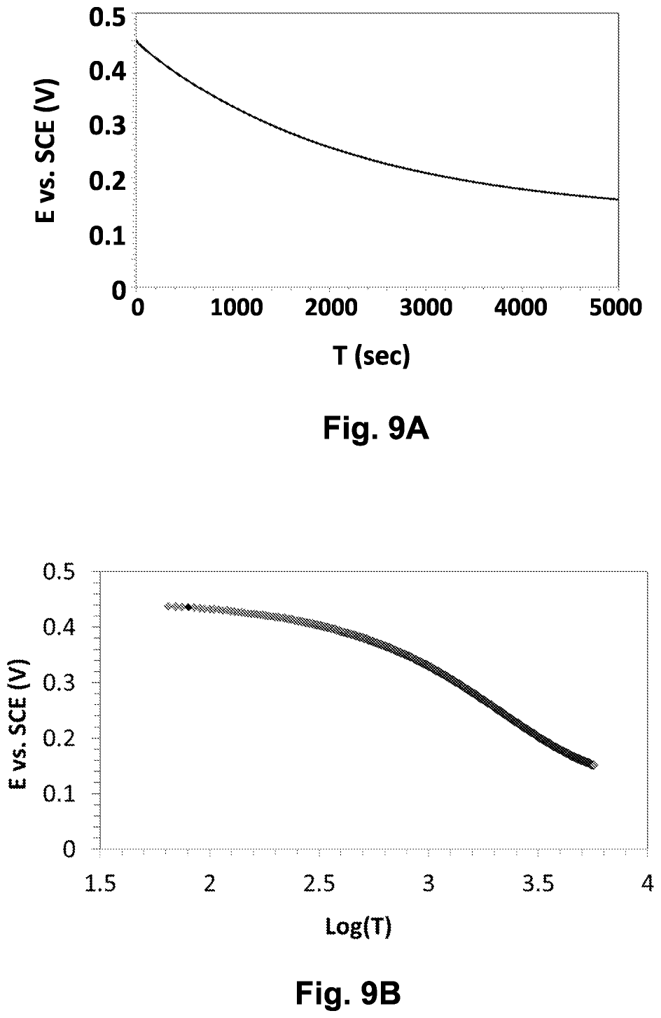

In order to demonstrate the determination of the self-discharge capacity (C_{sd}) of an electrode, a Kynol electrode was charged at constant voltage to +450 mV and kept at this voltage for 3000 seconds. As shown in FIG. 9A, the voltage was self-discharged over 5000 seconds. The self-discharge behavior follows the trend as mentioned above by equation 3:

$$C ( \frac{dE}{dt} ) = {I}_{0} {e}^{( \frac{α EF}{RT} )}$$

Due to the change in the slope, in order to accurately calculate the self-discharge capacitance, the different double layer capacitance in time and potential are summed according to the above-mentioned equation 4:

$${C}_{sd} = {\sum }_{t = 0}^{{t}_{f}} C ( \frac{dE}{dt} )$$

Equation 3 can be simplified by changing the time scale to a logarithmic scale, as shown in FIG. 9B. Thus, the summation of the C_{sd} can be plotted by two type of slopes, which are dependent on time.

### Example 5

### Steady-State Behavior of the Low Surface Area Electrode

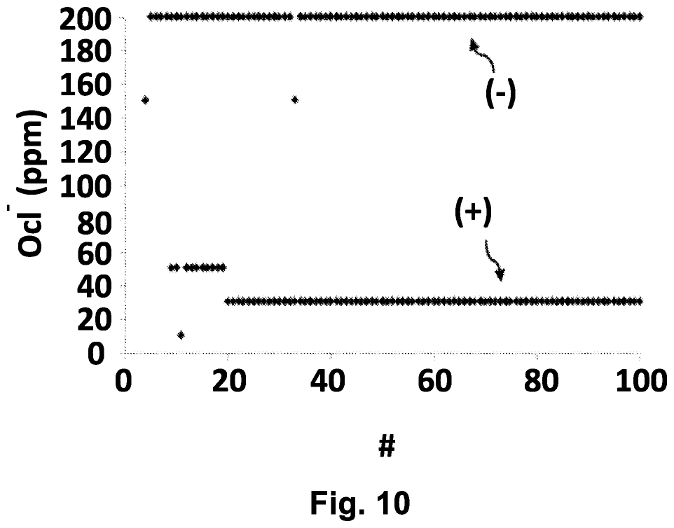

FIG. 10 plots hypochlorous anion (OCl⁻) concentration in ppm as a function of the charge/discharge cycle number (#) under constant current, applied to an electrochemical towelette containing a 1M solution of NaCl. Periodically, the low surface area electrode was positively polarized (+), using a constant current, up to a potential difference above 4 Volts (with respect to a reference electrode, in tap water), for 6 minutes, followed by negative polarization (−) for 2 minutes, to obtain a neutral environment around the electrode, until the next polarization cycle. It can be observed that the electrode exhibits a substantially steady-state behavior over 100 cycles.

### Example 6

### Acidic pH Development Over Time

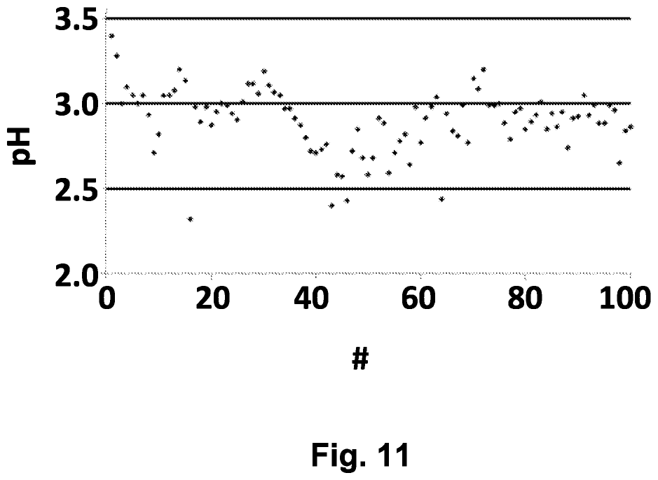

FIG. 11 is a plot of acidic pH development in the electrochemical towelette as a function of time (charge/discharge cycle number). The power source was controlled by the on-board CPU to apply a potential of 5 Volts. Under these illustrative and non-limitative operating conditions, the system stabilizes around pH 3, but of course higher or lower pHs can be achieved using the appropriate conditions.

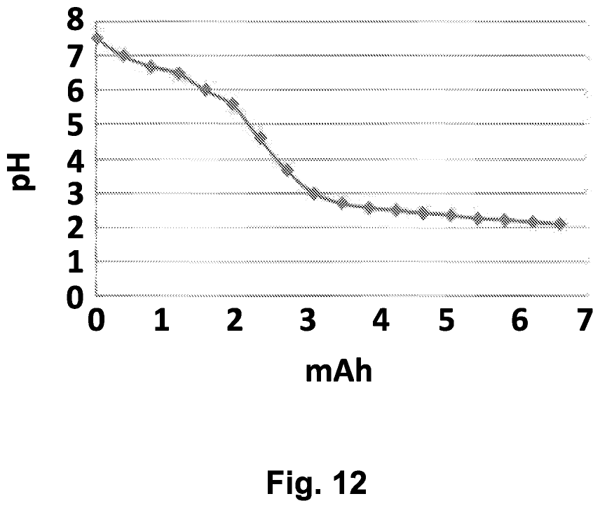

FIG. 12 is a plot of the pH development in the electrochemical towelette, as a function of the total charge consumption (in milliampere hour units, mAh), according to an embodiment of the present invention. The power source was controlled by the on-board CPU to apply a potential of 5 Volts. Under these illustrative and non-limitative operating conditions, the system stabilizes around pH 2, but of course higher or lower pHs can be achieved using the appropriate conditions.

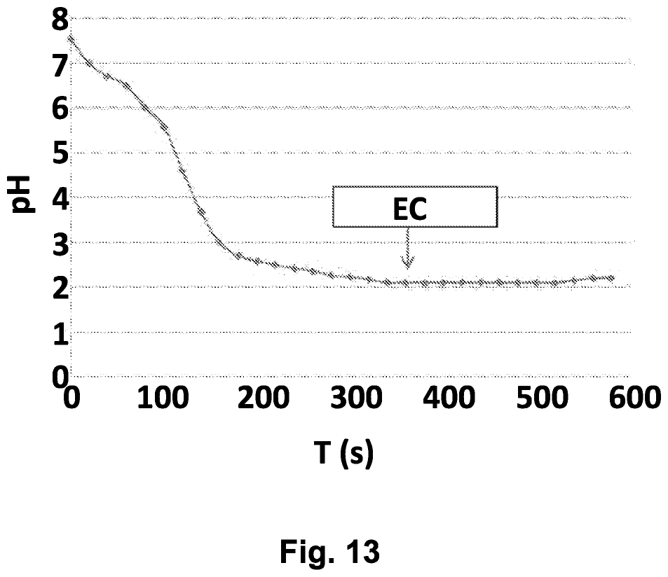

FIG. 13 is a plot of the pH development in a rectangular, 8×16 cm electrochemical towelette at the low surface area side as a function of time. A current was applied for the first 340 seconds. Then, the application of the potential was ceased. The power source was controlled by the on-board CPU to apply a potential of 5 Volts. The pH of the towelette surface was monitored using a surface pH meter (Orion). After about 150 seconds from the application of the potential, the acidity upon the surface of the towelette had dropped to a pH of around 3. After ceasing the application of the potential, the pH remained quite steady (around 2.1) during the remaining 3 minutes of the run. Here, of course, the charging can also be stopped at a higher pH, e.g., 5.5, which is suitable for application to the human skin, or at any other desired pH.

### Example 7

### The Potential Remains Steady Over Time

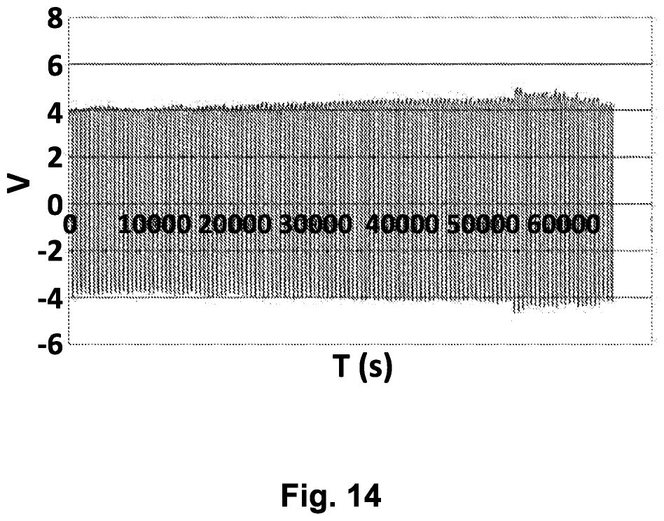

FIG. 14 is a plot of potential vs. time for an electrochemical towelette, according to an embodiment of the present invention. The potential, measured with respect to a reference electrode, is extremely steady at about 4 Volts, for multiple cycles with total duration in excess of 15 hours.

### Example 8

### No Changes in pH at the High Surface Area Side

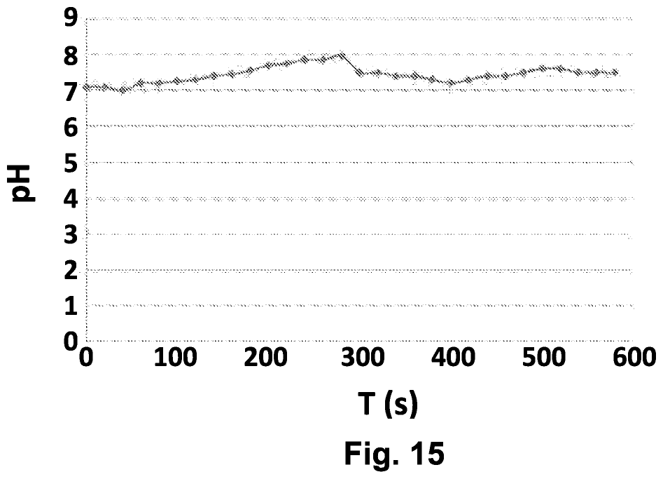

FIG. 15 is a plot of the pH development in the towelette (high surface area side) as a function of time, using the identical time scale of FIG. 13. The power source was controlled by the on-board CPU to apply a potential of 5 Volts. No major changes in the pH were observed, apparently because the main process transpiring was the adsorption of cations.

### Example 9

### Alkaline pH Development Over Time

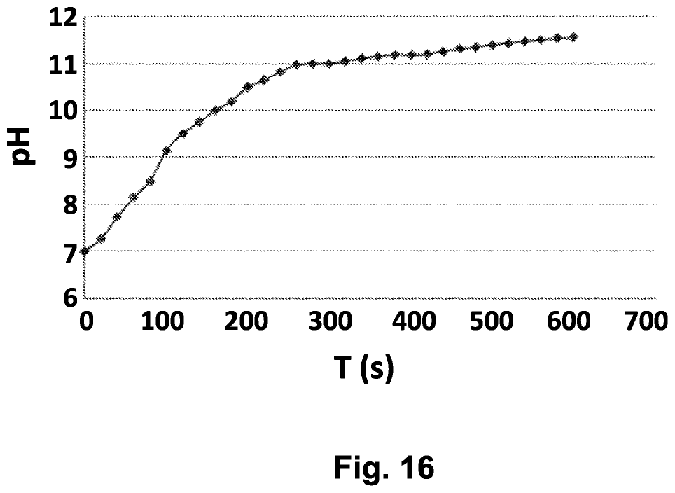

FIG. 16 is a plot of the pH development in the electrochemical towelette surface as a function of time, during the production of an alkaline solution, according to an embodiment of the present invention. The power source was controlled by the on-board CPU to apply a potential of 5 Volts. By negative polarization of the electrochemical towelette (or similarly, with the electrochemical sprayer) high pH values may be attained. In this example, a rectangular towelette of 8×16 cm in size was used. A potential difference of −5 Volts was applied to the towelette, and the pH of the towelette surface was monitored using a surface pH meter (Orion). It may be observed that a highly basic (pH>11) environment on the surface of the towelette was attained after about 5 minutes.

### Example 10

### The Anti-Microbial Efficacy of Electrochemical Towelettes

The anti-microbial efficacy of the inventive electrochemical towelettes having absorbed hypohalous solution was tested on colonies of Escherichia coli and Staphylococcus aureus. The colonies were grown to a concentration of about 10,000 microbes/ml on Petri plates. Mini electrochemical towelette pads (1.5×1.5 cm) were produced for this purpose. The pads were soaked in tap water (containing at least 150 ppm of sodium chloride solute) and were pre-charged to 5 Volts for 3 minutes. The pads were then placed on top of the respective bacteria colonies, in the middle of each Petri dish, for another 3 minutes of charge under 5 Volts.

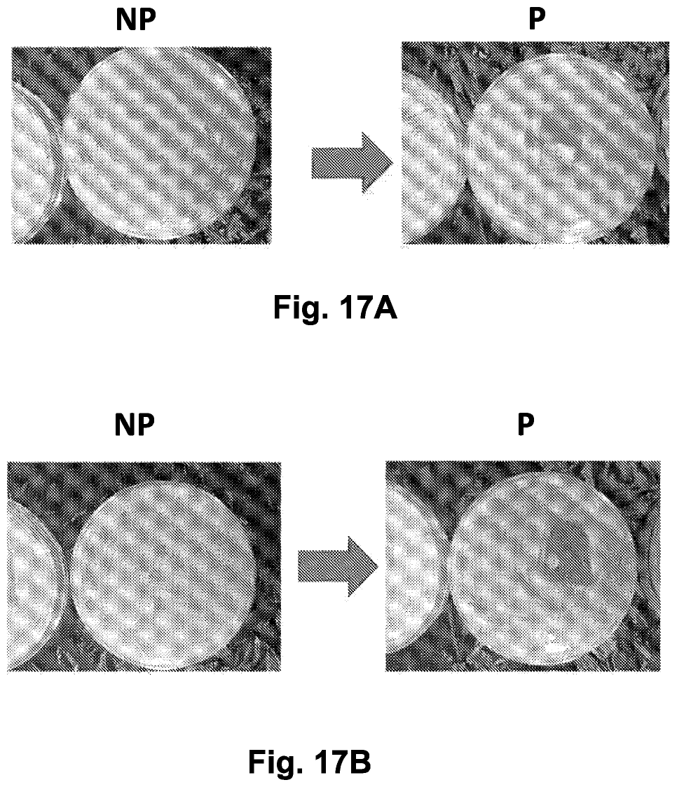

FIGS. 17A and 17B are photographs of Escherichia coli and Staphylococcus aureus colonies, respectively, grown in Petri dishes. Non-polarized (NP) or polarized (P) pads, soaked in tap water, were placed on top of the bacteria colonies for 24 hours. It may be seen that after the identical 24 hour period, the polarized pads lead to a central region in each of the bacteria cultures which is substantially devoid of bacteria, for both the Escherichia coli and the Staphylococcus aureus colonies. By contrast, in the central region of the colonies treated with non-polarized pads, no void regions were observed, indicating that the polarization of the tap water soaked in the pads was the cause behind the bactericidal effect of the electrochemical towelettes.

1. A device for generating an aqueous solution having a desired pH using an asymmetric electrochemical cell, comprising:
a cell housing;
at least one positive electrode within the cell housing;
at least one negative electrode within the cell housing; and
a power supply;
wherein the surface area of one of the electrodes is higher than the surface area of the opposite charged electrode by a differential determined by the equation:
pH=7×(1−n)+n×log[96485×V/(((([A⁻]−[A⁺])×n×ε/d)−C_{sd})×f×E)],
wherein:
pH is the desired pH of the aqueous solution;
V is the volume of the aqueous solution disposed within the device;
[A⁻] is the nominal surface area of the negative electrode;
[A⁺] is the nominal surface area of the positive electrode;
n is 1 when the negative electrode is the higher surface area electrode, or n is −1 when the positive electrode is the higher surface area electrode.
ε is the permittivity constant;
d is the distance between the surface adsorbed ions and the opposite charged electrode in an electrical double layer;
C_{sd} is the total self-discharge capacity of the high surface area electrode;
f is a normalizing factor; and
E is the overall electric potential of the electrochemical cell.

2. A device according to claim 1, wherein the normalizing factor is obtained by determining a theoretical surface area of a first electrode using the resulting pH from a plurality of experiments, determining the ratio between the theoretical surface area and an experimental surface area of said electrode for each pH obtained from a separate experiment, and averaging the ratios between the theoretical surface area and the experimental surface area of said electrode for each of said resulting pHs, to obtain the normalizing factor for a specific combination of electrodes.

3. The device of claim 1, wherein the high surface area electrode is surface-treated, such that it is continuously self-discharged.

4. The device of claim 3, wherein the high surface area electrode is grounded.

5. The device of claim 3, wherein the high surface area electrode comprises oxide functional groups.

6. The device of claim 1, which is a sprayer device.

7. The device of claim 1, which is a towelette.

8. A method of operating an asymmetric electrochemical cell device, comprising the steps of:
(a) determining a desired pH value of an aqueous solution, an overall electric potential of the electrochemical cell, a solution volume and a differential between the surface areas of the positive and negative electrodes, by the equation:
pH=7×(1−n)+n×log[96485×V/(((([A⁻]−[A⁺])×n×ε/d)−C_{sd})×f×E)],
wherein:
V is the volume of the aqueous solution disposed within the device;
[A⁻] is the nominal surface area of the negative electrode;
[A⁺] is the nominal surface area of the positive electrode;
n is 1 when the negative electrode is the higher surface area electrode, or n is −1 when the positive electrode is the higher surface area electrode.
ε is the permittivity constant;
d is the distance between the surface adsorbed ions and the opposite charged electrode in an electrical double layer;
C_{sd} is the total self-discharge capacity of the high surface area electrode;
f is a normalizing factor; and
E is the overall electric potential of the electrochemical cell.
(b) determining a magnitude and time of an electrical current to be applied between the positive and negative electrodes by the equation:
pH=14+log[96485×V/(I×dt)],
wherein:
V is the volume of the aqueous solution disposed within the device;
I is the electric current applied between the electrodes; and
dt is the time interval for applying said electric current;
(c) introducing said aqueous solution into the electrochemical device at the calculated volume V of step (a);
(d) applying the electric current determined in step (b) between the electrodes, until the desired pH of the resulting solution is obtained.

9. The method of claim 8, further comprising the steps:
(e) replenishing the volume of the solution in the device with the aqueous solution of step (c);
(f) reversing the polarization of the electrochemical cell device; and
(g) applying the electrical current between the reversed polarized electrodes, until the desired pH of the resulting solution is obtained.

10. A method according to claim 8, wherein the total self-discharge capacity of the high surface area electrode is different than 0 (zero) and said high surface area electrode is surface-treated such that it is continuously self-discharged.

11. A method according to claim 8, for producing a hypochlorous acid solution.

12. The method according to claim 10, wherein the concentration of the salt needed for obtaining a concentration of the hypochlorous acid (C_{HOCl}) is determined according to:
C_{NaCl}=(10^{-(7×(a-1)+pH}/V+C_{HOCl}×t/300
wherein:
C_{NaCl} is the required salt concentration in the solution disposed within the device, in Molar units (mole/Liter);
pH is the desired pH of the solution;
a is 1 when pH<7, or a is −1 when pH>7;
V is the volume of the solution disposed within the device;
C_{HOCl} is the desired concentration of the active material needed for a given application; and
t is the operating time of the device.

13. A method for controlling the pH of a solution containing a chloride derivative, comprising applying a current to a device according to claim 1 until the desired pH is obtained.
